(19) United States
(12) Patent Application Publication
(10) Pub. No.: US 2014/0282883 A1
(43) Pub. Date: Sep. 18, 2014

(54) SYSTEM AND METHOD FOR DISTRIBUTING, MONITORING AND CONTROLLING INFORMATION

(71) Applicants: Ronald Simon CHAN, Stoney Creek (CA); Peter John KARRYS, Oakville (CA)

(72) Inventors: Ronald Simon CHAN, Stoney Creek (CA); Peter John KARRYS, Oakville (CA)

(21) Appl. No.: 13/801,595

(22) Filed: Mar. 13, 2013

(51) Int. Cl. H04L 29/06

(52) U.S. Cl. CPC H04L 63/10
USPC 726/4

(57) ABSTRACT

A system and method for distributing, monitoring and controlling information is taught. The system and method allows for access to, and distribution of, information to be tightly controlled and yet, by the use of user and location classes and classifications, allows for the relatively simple definition of that access. The system and method permit the tracking of the activities within the system, including the distribution and use of the information by users, when they accessed the information and how frequently it was accessed, etc. The system and method is designed for the managed widespread distribution of information to a variety of types of users and yet can operate with relatively inexpensive computing equipment at user locations.

### FIELD OF THE INVENTION

The present invention relates to a system and method for controlling the dissemination of information. More specifically, the present invention relates to a system and method for distributing, monitoring and controlling information.

### BACKGROUND OF THE INVENTION

In many circumstances it is desired, or required, to distribute specific information to a variety of intended recipients and to monitor their use of the information while also preventing the distribution of that information to non-intended recipients.

Historical methods of performing such a task include having an agreement to keep the information confidential and then physically circulating the information with a list of one or more intended recipients and including a sign off sheet to track when/if the recipients have read the information, the sign off sheet being returned at some point to the distributer of the information. The possible inaccuracies, delay and risks associated with such historical systems will be apparent to those of skill in the art.

More recently, the methods of performing such a task have included emailing the information to intended recipients or providing the information on a website to which the intended recipients can be provided access. In either case, access to the information can be confirmed, via a read receipt (in the case of an email delivery) or a web server log entry (in the case of the web site), to determine that the intended recipient accessed the information.

However, in both of these cases, and with other known systems and methods, it is possible that non-intended recipients may access the information via access by the non-intended recipients to the intended recipient's email account or web site account or via the intended recipient intentionally or accidentally forwarding the information to the non-intended recipients, etc. Further, in many scenarios the intended recipients may not have convenient or timely email or Internet access and thus such techniques will not work in such cases.

Thus, the distribution, monitoring and control of information can be problematic. In fact, in some cases, it is particularly problematic due to legislative, regulatory and/or safety requirements.

For example, in many countries the marketing, distribution and sale of tobacco products is strictly regulated. In some jurisdictions, the marketing and advertising of tobacco products is prohibited, or strictly limited. While a tobacco producing company may be allowed to provide product information about brands and products to some functions in the purchasing, distribution, sales and retailing chain, the distribution of such information to entities other than those explicitly permitted can be a criminal offense. Furthermore, even within the purchasing, distribution, sales and retailing chain, different roles (e.g.—purchasing versus sales) have different legislative restrictions defined for them, so the information for one role cannot be provided to another role.

The marketing, distribution and sale of prescription and/or non-prescription pharmaceuticals can be subject to similar legislative restrictions, as can lottery ticket sales, other age restricted products, etc.

These issues are further exacerbated by the fact that the sales outlets for tobacco products, lotteries and other similar products often employ low-skilled laborers and/or are often very small commercial entities (i.e.—convenience stores, lottery kiosks, etc.) and such entities are typically too small to implement information management systems themselves, yet their owners, and the companies that deal with them, may be criminally liable for violations of legislation relating to the distribution of information.

As will also be apparent to those of skill in the art, it may be desired to safely distribute information to tens of thousands (in the case of convenience stores, for example) of intended recipients and thus any practical distribution system must be cost effective on a per user basis and must be simple and effective for even unskilled users.

Accordingly, it is desired to have some way of safely and cost effectively distributing necessary information to a variety of intended recipients and to monitor their access to that information.

### SUMMARY OF THE INVENTION

It is an object of the present invention to provide a novel system and method for distributing, monitoring and controlling information which obviates or mitigates at least one disadvantage of the prior art.

According to a first aspect of the present invention, there is provided a system for distributing, monitoring and controlling Information for a plurality of users, comprising: an information management server including: an information database to store information for users of the system; a communities database containing definitions of classes to which users of the system may be assigned; a location database containing definitions of locations where information the system can be presented to users; an audit engine operable to record a selected set of activities of a user with respect to information presented to the user; a user database defining user records for users of the system, the user records including user login credentials and at least one class from the communities database to which the user has been assigned; and a matching engine operable to match users to information in the system which is to be distributed to the matched users; a plurality of computing devices, each computing device including an information rendering engine operable to present information to a user and a security engine operable to authorize the presentation of the information in the cache to the user in accordance with metadata defined for the information; and a data communications network operable to transfer the information and associated data between the plurality of computing devices and the information management server.

Preferably, when a user of at least one of the plurality of computing devices provides login credentials to the security engine and the security engine compares those credentials to the login credentials stored in the user database to authorize the presentation of information to the user. Also preferably, the at least one of the plurality of computing devices includes location determination technology to determine a location of the at least one computing device and wherein the metadata defined for the information defines at least one location at which presentation of the information to a user is permitted, the security engine of the at least one computing device operable to determine the location of the at least one computing device and to compare that determined location to the defined at least one location in the metadata and to permit the information rendering engine to present the information to the user.

Also preferably, the metadata defines at least one user activity of interest with respect to the presentation of the information to the user, the computing device recording the performance of the at least one activity of interest by the user and forwarding a record thereof to the audit engine.

According to another aspect of the present invention, there is provided a method of distributing, monitoring and controlling information for a plurality of users, comprising the steps of: (i) loading information to be distributed to at least one of a plurality of users into an information management server; (ii) defining metadata for the loaded information, the metadata specifying at least one class of user that the information is to be distributed to; (iii) receiving from at least one of a plurality of computing devices connected to information management server by a data communications network, a set of login credentials from at least one user; (iv) determining if the login credentials are valid and, if they are, logging in the user; and (v) presenting the information to the user if the user is a member of a class that corresponds to the specified at least one class.

Preferably, the metadata further specifies at least one authorized location and wherein the login credentials from the user include a determined location of the user and, in step (v) the information is only presented to the user if the determined location corresponds to the at least one authorized location. Also preferably, the information management server maintains a database of classes of which users can be members and step (ii) comprises selecting at least one class from the database of classes.

The present invention provides a novel system and method for distributing, monitoring and controlling information. The system and method allows for access to, and distribution of, information to be tightly controlled and yet, by the use of user and location classes and classifications, allows for the relatively simple definition of that access. The system and method permit the tracking of the activities within the system, including the distribution of the information and the access by users to the information (preferably including the number of times the information is accessed and the times and dates of those accesses). The system and method is designed for the widespread distribution of information, and management of access to that information, to a variety of types of users, and yet can operate with relatively inexpensive computing equipment at user locations.

### BRIEF DESCRIPTION OF THE DRAWINGS

Preferred embodiments of the present invention will now be described, by way of example only, with reference to the attached Figures, wherein:

FIG. 1 shows a schematic representation of a system in accordance with the present invention;

FIG. 2 shows a block functional diagram of an information management server of the system of FIG. 1;

FIG. 3 shows a block functional diagram of a computing device of the system of FIG. 1;

FIG. 4 shows a flowchart of the method of loading information into the system of FIG. 1; and

FIG. 5 shows a flowchart of the method of a user requesting information from the system of FIG. 1.

### DETAILED DESCRIPTION OF THE INVENTION

A system for distributing, monitoring and controlling information, in accordance with an embodiment of the present invention, is indicated generally at 20 in FIG. 1.

As shown, system 20 comprises an information management server 24 and a plurality of computing devices 28 which can communicate with information management server 24 through a data communications network 32.

The implementation of information management server 24 is not particularly limited and can be achieved in a wide variety of manners as will occur to those of skill in the art. For example, information management server 24 can be implemented as a general purpose computing device, such as a Dell or other manufacturer's blade server executing a suitable operating system such as BSD Unix, Linux or Microsoft Windows Server. As will be apparent, a variety of alternative configurations and arrangements of computing hardware, including multi-server configurations, virtual machine-based configurations and/or distributed cloud computing can be employed as desired.

Information management server 24 can execute custom software, as described further below, which can be written in any suitable language or combination of languages as will occur to those of skill in the art, as well as a variety of commercially available software applications or open source software applications.

Computing devices 28 can be any of a wide variety of general purpose computing devices which include a processor suitable for executing a program to display information from information management server 24 to users and to receive input from those users, while communicating with information management server 24 through data communications network 32. Preferably, computing devices 28 are mobile devices which permit computing devices 28 to be moved within a commercial premise and/or in some cases, permit computing devices 28 to be moved between commercial premises locations. Accordingly, preferably computing devices 28 further include a GPS receiver and/or other location determination technologies such as so called WiFi-based fingerprint recognition and/or cellular network-based triangulation systems, etc. which allow computing devices 28 to determine their location in accordance with some specified criteria. Also, the location determination technology can employ a barcode scanner, magstripe, RF card reader, etc. which scans an identifier which is only available at a location.

Present examples of computing devices 28 include iPad tablets, manufactured by Apple Inc, or other analogous tablet computing devices such as the Samsung Galaxy, or laptop computers, smartphones executing the iOS, Android or other suitable operating systems, or purpose built computing devices such as dedicated kiosk stations. However, the actual selection and/or configuration of computing devices 28 is not particularly limited and it is contemplated that a wide variety of general purpose computing devices or purpose built computing devices can be employed as desired. If is further contemplated that, in system 20, computing devices 28 need not all be from the same manufacturer; nor be the same type of devices. For example, some computing devices 28 can be Apple-brand iPads while other might be purpose built kiosks or general purpose laptop computers.

Data communications network 32 can be any data communication network suitable for providing bi-directional data communications between information management server 24 and computing devices 28. In a presently preferred embodiment, data communications network 32 is the Internet and can include wired and/or wireless links, both cellular wireless data links and WiFi wireless data links, but it is also contemplated that a private data network (wired or wireless) or combinations of both private and public networks can be employed if desired.

Thus, in system 20, computing devices 28 are used at locations to which it is desired to distribute information. Accordingly, computing devices 28 can be located at retail premises, other commercial premises and/or computing devices 28 can be mobile, accompanying sales representatives, management or other interested individuals. As will be apparent, in the case of computing devices 28 being mobile, such computing devices 28 are equipped with suitable technology to enable communication between the mobile computing devices 28 and data communications network 32, at least at locations where it is desired to use computing devices 28.

FIG. 2 shows information management server 24 in more detail. As mentioned above, information management server executes software to provide a number of functionalities. One of these functionalities is information database 100 which is operable to receive, store and make available information which is loaded into information server 24 for distribution to one or more of computing devices 28 and to maintain metadata about the information to be distributed. It is contemplated that users of system 20 can include entities such as tobacco companies, pharmaceutical companies, etc. (herein after “clients”) which need to distribute information in a controlled and managed way. Such clients will load the information they wish distributed into information database 100.

Information database 100 can also remove information from system 20 at specified times. If for example, information in information database 100 is superseded by new information, information database 100 can delete the outdated information from system 20. Similarly, if information in information database 100 relates to a time-limited sales campaign (or any other time-limited information), information database 100 can remove such information from system 20 after it has expired.

Another functionality implemented in information server 24 is a communities database 104. Communities database 104 allows for the creation of a set of classes, or communities, into which users of system 20 can be arranged. These communities are not mutually exclusive and allow for users of system 20 to be organized in a variety of useful manners. Non-limiting examples of classes defined in communities database 104 include: retail outlet types (i.e.—gas bar; convenience store; pharmacy; electronics store; etc.); roles (e.g.—sales clerk, pharmacist's assistant; purchasing agent; sales representative; etc.); work arrangements (e.g.—night shift; full time, part time, temporary worker, etc.). Thus, a non limiting example of a community might comprise users who are: employees at convenience stores, in Ohio, as sales clerks, are responsible for selling tobacco products and lottery tickets as part of their job and work the night shift. As will be apparent, a wide variety a communities can be defined and employed to allow system 20 to easily and effectively distribute information to users with an exact, and easy, ability to specify the relevant users.

Another functionality implemented in information management server 24 is user data base 108. User database allows the definition of users in system 20, where a user is an individual to whom some information in information database will be made available (i.e.—the information “users”).

User records can be created by clients who are aware of, and have the necessary information for, the users who are the intended recipients for their information distribution, can be created by the users themselves as part of an initial set up process that would preferably be managed by their employer, can be created by the employer of the users or via any other suitable method as will occur to those of skill in the art. It is contemplated that user records can include a wide range of information relating to a user, such as age, gender, shift worked, years of experience, etc.

As part of the creation of the user record, it is contemplated that users will automatically be associated with one or more communities (based upon their employer, industry type, job position, physical location of their employer, etc.) and that users may also be able to select one or more communities that they optionally wish to belong to (i.e.—employees wishing to upgrade their product knowledge, etc.)

As a non limiting example, a user may have a record defined for him or her which defines the user's login data (e.g.—username and password), but which also associates that user with an industry group (e.g.—convenience store, pharmacy, etc.), an employment role (e.g.—sales clerk, purchasing clerk, pharmacist's assistant, etc.), an employment location (e.g.—city, state or province). It is contemplated that the entries for these categories, and others, will be mandatory and will not be editable by the users themselves, but will instead be filled by the user's employer or other authorized entity.

The user record for a user can also maintain additional information about a user, such as any training offered through system 20 which the user has completed, how often they access the system, whether they have earned any rewards from the system, training certificates and/or accreditations earned by the user through the system, etc.

Another functionality implemented in information management server 24 is a locations database 112. Locations database 112 allows for the definition of locations where information from information management server 24 is to be provided to. Locations can include physical addresses, such as street addresses and, preferably, also includes other information which can be used to recognize a location such as an IP address, or range of addresses, GPS coordinates (lat and long), WiFi “fingerprints” (SSIDs and related signal strengths), cellular fingerprints (Cell tower IDs and reception strengths or cell tower locations), MAC addresses, etc. As described in more detail below, this other location information can be employed by system 20 to control the distribution of information as desired.

The locations database 112 also preferably includes information defining relevant classes of locations, such as the type of the industry at the location (i.e.—convenience store; gas bar; purchasing office, head office, etc.) and the proprietor of the location (i.e.—Exxon, Shell, etc.) and can also include additional relevant class information about the commercial activity at the location (i.e.—24 hour outlet, drive through present, etc.).

Locations database 112 can also include specifics about the locations, such as: hours the location is open/operates; the size of the store/number of sales clerks; categories of products sold (i.e.—propane, beer, fast food, etc.); type of location (i.e. store located in a mall, stand alone store, etc.)

Finally, locations database 112 also records the availability of computing devices 28 at the location. It is contemplated that at some locations (particularly large commercial enterprises) multiple computing devices 28 may be present while at other, small, locations a computing device 28 may only be available when a sales representative or other person is physically present and has brought a mobile computing device 28 with them.

Another functionality implemented in information management server 24 is an audit, or compliance, engine 116. At its simplest, audit engine 116 maintains records of which users have accessed information provided to them and a variety of related information, such as when that access occurred, how often the user accessed the information, how long the user spent reviewing the information and when those accesses occurred, etc.

Thus, a client can determine which users have received information from that client and can have an indication of “take up” of the information by users. This can be particularly useful when the information being distributed is required by law to be distributed to a class of users (pharmaceutical information or lottery sales restrictions training information, etc) or is desired for liability reduction considerations (a recall of a defective or dangerous product), etc. In such a case, a client can determine, at some period of time after the distribution of the information to the desired set of users, how many of those users have reviewed the information, when they reviewed it and how long they spent reviewing it.

Audit engine 116 can also record feedback from users, either ad hoc comments or responses to predefined questions in the information provided to the user. Further, in the case that the information provided to the user was, or included, a survey or other request/requirement for information from the user, audit engine 116 can receive the information (e.g.—survey responses, questionnaire responses, photographs of product displays with or without GPS or other location identifiers, etc.) and can tabulate responses and/or provide that information to the client.

Audit engine 116 also cooperates with information database 100 to allow a client to define a schedule for the number of times information is to be viewed by a user, the periodicity of those viewings and to record whether users in fact access the information in accordance with that defined schedule. In this way, information relating to important training or regulatory issues, etc. can be reinforced by ensuring repetition of the presentation of that information to users at specified intervals. As will be apparent, audit engine 116 will record user compliance with such schedules and can generate reports identifying non-compliant users to allow a client of system 20 to take remedial steps.

Audit engine 116 can therefore be used to ensure that desired, or mandatory, training has been performed by users at required times and/or that important information has been reviewed by users, for such uses. The clients of system 20 can easily define that such materials be distributed to specific users or to members of any class of users such as manufacturers, retail outlet owners, regulatory bodies, etc.

Finally, information collected in audit engine 116 can be used to identify and recognize behaviors of individual users, and communities of users, allowing training and/or rewards programs to be tailored to better more effective and to better suit users and clients.

Another functionality implemented in information management server 24 is matching engine 120. Matching engine 120 is operable to, in response to input from a client, identify the users to whom information is to be provided. Such matching can be performed in a variety of manners, as will be apparent to those of skill in the art, and can be as simple as identifying users in a particular industry which has been targeted (i.e.—identifying users working at convenience stores to receive information about new candy products) or identifying users at a specific location (i.e.—a country, province or state, city, or part of a city) or identifying users at a type of location (i.e.—gas bars with a drive thru, convenience stores with lottery sales outlets, etc.) or any combination of class memberships for a user as desired. In addition, matching engine 120 can also use information from locations database 112 to identify matching users to which the information is to be presented. For example, a client may wish to only present information to convenience store clerks working at convenience stores which sell gasoline on a 24 hour basis, etc.

In this manner, a retailer can launch a program targeting particular types of retail outlets (i.e. convenience stores) in a particular city of state or region. Similarly, a client can target users in a specific region (i.e. a state) for mandatory training if required by new state legislation regarding the sale of tobacco products, etc.

Further advantages and uses of the functionalities of information management server 24 will be described below.

As mentioned above, computing devices 28 can be implemented in a wide variety of manners provided only that they include, at a minimum, a processor and associated hardware suitable for executing a program to display appropriate information from information management server 24 to users and to receive input from those users, while communicating with information management server 24 through data communications network 32. More preferably, computing devices 28 further include a GPS receiver and/or other location determination technology such as WiFi-based and/or cellular network-based triangulation systems, etc. which allow a computing device 28 to determine its location to some extent (as described further below).

As shown in FIG. 3, computing devices 28 implement an information rendering engine 200 which is operable to receive information from information management server 24, via data communications network 32 and to present that information to users of device 28. Information to be rendered to users is only limited by the hardware and features of computing device 28 and can include text information, information on html pages, video information, audio information, on screen or printable UPC and/or QR codes, printable (or electronic) coupons, interactive information such as question and answer surveys, or training and/or marketing related interactive games, etc. and combinations of these types of information.

Information rendering engine 200 is further operable to collect input from users, for example from a keyboard or touchscreen of computing device 28, and to forward that information to information management server 24 and/or to interactively update information rendered by information rendering engine 200 for presentation to a user. For example, if a user responds to a survey presented by information rendering engine 200, the user's responses will be forwarded to information management server 24. Similarly, a user may respond to a prompt (e.g.—“Do you wish to see a short video providing more information about this product?”) in the information presented by information rendering engine 200 by presenting that video to the user on computing device 28.

It is also contemplated that computing device 28 can also include one or more of a digital camera, a barcode scanner, a magnetic stripe reader, near field communication (NFC) device, temperature sensor, barometer, magnetic compass, etc. to allow users to gather information at their location and information rendering engine 200 is operable to transfer that information to information management server 24, as desired.

Examples of the implementation of information rendering engine 200 can include custom software, commercially available software such as, for example, Adobe's PDF Reader, Webkit based html browser engine, open XML document standards such as, but not limited to, DOCX, XLSX, PPTX and/or combinations of these technologies and other technologies as will occur to those of skill in the art.

Computing devices 28 also implement a security engine 204 which performs a variety of functions relating to device and account security, including well known techniques for implementing user logins and passwords to permit access to information on computing device 28, as well as providing a caching system for securely storing information on device 28.

In particular, it is contemplated that system 20 will be used to distribute sensitive information which is desired (or required by statute) to only be accessible to only some users of system 20. For example, in some jurisdictions it is legal to provide some level of tobacco marketing information to users who are involved in the process of purchasing (for retail distribution) such tobacco products, while it is illegal to make such information available to the public, or even to sales clerks who sell such products. Similarly, it may be legal to provide some tobacco product information to sales clerks, but not to the general public.

Accordingly, in the present invention security engine 204 operates to restrict access to information from information management engine 24 to specified users. Information received from information management server 24 is stored within computing device 28 in a cache 208 secured by security engine 204.

Preferably, information received at computing device 28 is encrypted by security engine 204 and is stored in cache 208 in that encrypted form. Information in cache 208 must be decrypted by security engine 204 before information rendering engine 200 can use the information and present the information to a user. The unencrypted form of the information is held in a transient memory of information rendering engine 200 such that after a properly authorized user has accessed the information, the transient copy is deleted to prevent subsequent unauthorized access. However, the encrypted form of the information can be maintained within cache 208 to allow for subsequent access to the information if desired.

Cache 208 allows for faster access to information by users (i.e.—information which has previously been downloaded need not be downloaded again) and allows for authorized access to information which has been previously transferred to computing device 28 even when computing device 28 is no longer connected to data communications network 32.

However, it should be apparent to those of skill in the art that cache 208 is merely a preferred feature and that computing device 28 need not include cache 208. In such a case, information requested by a user will be transferred from information management server 24, as needed, over data communications network 32. In such cases, it is preferred that the information be transferred through data communications network 32 in an encrypted format or via an encrypted channel (i.e.—a VPN or SSL connection). In any event, security engine 204 still operates to prevent a user to access information which the user is not authorized to access.

The specification of users authorized to access information can be achieved in a variety of manners, including the designation of specific individual users (e.g.—John Smith or Fred Jones—using their associate usernames within system 20). However, it is contemplated that in most cases, intended access to information will be specified via users' membership in the classes of users previously defined in Communities Database 104 (i.e.—users who are defined as being members of the class “convenience store purchasing agents” or “gas bar sales clerks”, etc.).

It is further contemplated that, especially in the case of computing devices 28 which are mobile, it is desired to prevent access to information from information management server 24 when the computing device is not at a specified location. For example, it may be desired to prevent access to tobacco product information if a computing device 28 from which access is requested is not located at a specified convenience store, even if the user requesting the information is otherwise authorized to access that information.

As will be apparent to those of skill in the art, in such a case location information for the specified convenience store (or other location) is maintained in Location Database 112 in information management server 24. This location information can comprise all or any of: GPS coordinates for the convenience store (Lat and Long); the SSID of a WiFi network within the store and which forms part of data communications network 32; the IP address assigned to computing device 28; a WiFi or cellular data “fingerprint”, etc.

When access to such restricted information is requested by a user, security engine 204 will query the appropriate hardware on computing device 28 to determine the location of computing device 28 and will compare that location data to the data stored in Location database 112 (which can have been previously transferred to cache 208 on computing device 28, or which can be accessed through data communications network 32). If the determined location matches a permitted location stored in Location Database 112, security engine 204 will permit access to the information, either from cache 208 or via transfer from information management server 24 via data communications network 32.

If the determined location does not match an authorized location in Location Database 112, then access to the information is prohibited and a suitable status message is displayed to the user.

Thus, for example, a sales representative who moves computing device 28 from one retail location to another cannot access location-restricted information from computing device 28 until the sales representative is again at a specified permitted location. It will be apparent to those of skill in the art that not all information accessed from a computing device 28 need have location access restrictions defined for it.

In addition to client information from information management server 24, security engine 204 also maintains a copy of relevant information from locations database 112 and relevant user information from user database 108 to permit authorized users to access information from cache 208 when computing device 28 is not connected to data communications network 32 (i.e.—computing device 28 is “offline”). Further, any user activity information which would have been forwarded to audit engine 116, if computing device 28 was connected to data communications network 32, is stored in cache 208.

While it is contemplated that these copies of relevant information can be complete copies of user database 108 and location database 112, it is preferred that these copies of relevant information be subsets of the total information of user database 108 and location database 112 (to reduce data transmission requirements and storage size requirements at computing device 28) and are selected and forwarded from information management server 24 corresponding to the information in cache 208. Thus, for example, if cache 208 contains information which is limited to being accessed at a dozen different locations, those dozen locations will be forwarded from location database 112 to cache 208.

Conversely, if cache 208 does not contain any information restricted to being accessed from specific locations, no location information will be forwarded to computing device 28.

Similarly, user information from user database 108 can be selectively transferred to cache 208 in a variety of manners, such as maintaining copies in cache 208 of the last 50 users who have logged into computing device 28, or other suitable caching strategies as will occur to those of skill in the art.

Thus when computing device 28 is offline, security engine 204 can employ the local copies of the relevant information from user database 108 and location database 112 to verify access to information stored in cache 208.

When computing device 28 is once again connected to data communications network 32, the copies of relevant information in cache 208 can be updated, as necessary, to bring them into agreement with the information stored at information management server 24 should any changes have been made to that information while computing device 28 was offline. Also, any user activity data stored in cache 208 is forwarded to audit engine 116.

As should also now be apparent, a client of system 20 need not individually specify permitted locations for accessing of information. Instead, the client can specify a class of location (i.e.—purchasing office, retail outlet, etc.) at which the information is to be available.

Security engine 204 also cooperates with information rendering engine 200 such that appropriate audit and compliance information is forwarded to Audit Engine 116. In particular, log records of activities are provided to Audit Engine 116 indicating, amongst other things, which user accessed which information at which time and at which location.

FIG. 4 shows a flowchart of the method of a client loading information into system 100. The method starts at step 300 wherein a client loads into information management server 24 the information they desired to have distributed and metadata defining the use and distribution of that information. The information to be distributed will have been previously created by the client, either for other uses or specifically for use with system 20. As mentioned above, this information can comprise a variety of information types including text, html, video, audio, interactive components such as surveys, etc.

Once the information has been loaded at step 300, the client next loads the metadata defined (or to be defined) for that information, beginning that process at step 304 where the users and/or class or classes of users to whom the information is provided. While a client can specify individual users to receive the information, it is contemplated that the more common approach will be for the client to select one or more classes of users, and/or other criteria, to specify the intended audience.

For example, a manufacturer of chocolate bars who is introducing a new product to a selection of states can specify that users who are members of the “convenience store” class and are members of classes “purchasing agent” or “sales clerk” and are located in one of the desired target states are to receive the information. Further, for important information and/or training materials, the client can specify that they wish the users to access the information a specified number of times (e.g.—three), and the interval between accesses (e.g.—every ten days).

The metadata specified by the client can also define an expiry time for the information, after which time it will be removed from system 20.

At step 304 the client also specifies any security criteria metadata associated with the distribution of the loaded information. For example, as discussed above, the distribution of information regarding tobacco products is sensitive and the client can specify that such information is only to be accessible in specified locations. Again, the specification of a location can be made in a variety of manners, including picking specific locations from within Location Database 112, but is contemplated that more commonly the client will select a class of locations at which the information may be accessed, such as “purchasing offices”, or “sales outlets”. The client can also specify other restrictions on access to the information, for example specifying a minimum age for the users having access to the information.

The client can also define metadata to restrict access to information to users who meet selected criteria. For example, access to detailed information about a new product may be restricted to users who have first completed an online training program (as tracked and recorded by Audit Engine 116).

The method continues at step 308 where the client specifies any Audit or Tracking information that may be desired relating to the distribution of the information. For example, the client can request that they be informed daily as to how many users have accessed the information or the client can request a report identifying the users who have not accessed the information. As will be apparent, a wide variety of such audit and tracking information can be provided, via Audit Engine 116, to the client, including how long a user spent access the information, what time of day they accessed it, where they were located when they accessed the information, etc.

The method completes at step 312 wherein information management server 24 examines the metadata criteria specified at step 304 and determines each user in user database 108 to whom the newly loaded information should be distributed. For each determined user, information management server 24 adds an appropriate designator to the respective entry in user database 108 for the determined user which indicates that new information is available to that user and specifies what that information is.

FIG. 5 shows a flowchart of the method of a user access to information on system 20 when computing device 28 is connected to data communications network 32. The method commences at step 400 wherein the user logs in to a computing device 28. Typically, this login process merely comprises the user appropriately identifying themselves to computing device 28 by entering a pre-assigned username or other identifier, along with a valid password or other security token, although any other suitable means of authenticating a user to system 20 can also be employed if desired. For example, an employee ID badge can be scanned by a computing device 28 to identify the user after which computing device 28 prompts them to enter their password, etc. Once the user has entered the login data, security engine 204 communicates the user identifier and security token to information management server 24.

Information management server 24 uses the received user identifier and security token with information from user database 108 to authenticate the user. If the user is authenticated, information management server 24 examines the entry for the authenticated user in user database 108 to see if any designators are associated with that entry.

If one or more designators (indicating the presence of information which has not previously been accessed by that user) are associated with the authenticated user, then at step 408 information management server 24 provides a description of the newly available information to information rendering engine 200 in the computing device 28 employed by the user to allow the user to see the description of the newly available information.

It is contemplated that the description provided to the user can indicate if access to the information is restricted to one or more specific locations and/or if particular information is mandatory for the user to access (as may be the case with updated company policies of the user's employer, or safety training materials, etc.) and/or any other information the user may need to be informed of.

At step 412, the user can indicate, via input to information rendering engine 200, the information that they wish to access, whether that is information which they have previously accessed or newly available information, and that request is sent information management server 24 from computing device 28. In a present embodiment of the invention, this request also includes location information from computing device 28 which can be used both as an audit function, indicating where a user was when they accessed information but also to ensure that any location restrictions defined for requested information have been met. In the case where a user is attempting to access location-restricted information but is not at an approved location, a suitable error message will be presented to the user and no transfer of the information will occur.

At step 416, information management server 24 receives the request for the information and ensures that all relevant criteria for distribution of that information is met. In addition to the identity of the user, relevant release criteria can include the time of day (information may be described to the user as only being available after a specific time, i.e. close of business, etc), the location of the requesting computing device 28, etc.

At step 420, information management server 24 transfers a copy of the requested information to information rendering engine 200 in the requesting computing device 28 and the user can access that information.

The method completes at step 424, wherein a record of the user's activities with the accessed information (e.g.—time and date the user began to read the information and the time and date they finished reading the information, etc) are forwarded to audit engine 116.

As will be apparent to those of skill in the art, audit engine 116 can be employed to collect and maintain records of each user's activities within system 20, including what information is distributed to the user and when, the time the user spent reviewing the information, any input the user made with respect to questions or choices in the information etc.

If computing device 28 is offline, a similar process occurs but the copies of the relevant user information and location information in cache 208 are used to authorize access to information, if it is stored in cache 208, and records of the user's activities are stored in cache 208 for subsequent forwarding to audit engine 116 when computing device 28 is next connected to data communications network 32.

As should now be apparent, the present invention provides a novel system and method for distributing, monitoring and controlling information. The system and method allows for access to, and distribution of, information to be tightly controlled and yet, by the use of user and location classes and classifications, allows for the relatively simple definition of that access. The system and method permit the tracking of the activities within the system, including the distribution and use of the information by users. The system and method is designed for the managed widespread deployment, to a variety of types of users and yet can operate with relatively inexpensive computing equipment at user locations.

The above-described embodiments of the invention are intended to be examples of the present invention and alterations and modifications may be effected thereto, by those of skill in the art, without departing from the scope of the invention which is defined solely by the claims appended hereto.

1. A system for distributing, monitoring and controlling Information for a plurality of users, comprising:
an information management server including:
an information database to store information for users of the system;
a communities database containing definitions of classes to which users of the system may be assigned;
a location database containing definitions of locations where information the system can be presented to users;
an audit engine operable to record a selected set of activities of a user with respect to information presented to the user;
a user database defining user records for users of the system, the user records including user login credentials and at least one class from the communities database to which the user has been assigned; and
a matching engine operable to match users to information in the system which is to be distributed to the matched users;
a plurality of computing devices, each computing device including an information rendering engine operable to present information to a user and a security engine operable to authorize the presentation of the information in the cache to the user in accordance with metadata defined for the information; and
a data communications network operable to transfer the information and associated data between the plurality of computing devices and the information management server.

2. The system of claim 1 wherein a user of at least one of the plurality of computing devices provides login credentials to the security engine and the security engine compares those credentials to the login credentials stored in the user database to authorize the presentation of information to the user.

3. The system of claim 2 wherein the at least one of the plurality of computing devices includes location determination technology to determine a location of the at least one computing device and wherein the metadata defined for the information specifies at least one location at which presentation of the information to a user is permitted, the security engine of the at least one computing device operable to determine the location of the at least one computing device and to compare that determined location to the defined at least one location in the metadata and to permit the information rendering engine to present the information to the user.

4. The system of claim 3 wherein the location determination technology comprises at least one of a: GPS receiver; a WiFi fingerprint recognition system; or a cellular telephone triangulation system.

5. The system of claim 3 wherein the location determination technology comprises a scanner operable to scan an identifier which is only available at a specified location.

6. The system of claim 1 wherein the metadata also defines the number of times the information is presented to the user.

7. The system of claim 6 wherein the metadata further defines the periodicity with which the information is presented to the user.

8. The system of a claim 1 wherein the metadata defines at least one user activity of interest with respect to the presentation of the information to the user, the computing device recording the performance of the at least one activity of interest by the user and forwarding a record thereof to the audit engine.

9. The system of claim 1 wherein the information includes information requesting a response from a user and the at least one computing device receives the response from the user and forwards that response to the audit engine.

10. The system of claim 1 wherein at least one of the plurality of computing devices further includes a cache, the cache operable to store information from the information management server for access by a user when the at least one computing device is offline and to store information to be forwarded to the information management server until the at least one device is connected to the information management server.

11. The system of claim 10 wherein the contents of the cache are encrypted and the security engine is operable to decrypt information from the cache for presentation to a user only after the security engine has determined that the user is authorized to access the information.

12. The system of claim 1 wherein the metadata includes an expiry time after which the information is to be removed from the system.

13. A method of distributing, monitoring and controlling information for a plurality of users, comprising the steps of:
(i) loading information to be distributed to at least one of a plurality of users into an information management server;
(ii) defining metadata for the loaded information, the metadata specifying at least one class of user that the information is to be distributed to;
(iii) receiving from at least one of a plurality of computing devices connected to information management server by a data communications network, a set of login credentials from at least one user;
(iv) determining if the login credentials are valid and, if they are, logging in the user; and
(v) presenting the information to the user if the user is a member of a class that corresponds to the specified at least one class.

14. The method of claim 13 wherein the metadata further specifies at least one authorized location and wherein the login credentials from the user include a determined location of the user and, in step (v) the information is only presented to the user if the determined location corresponds to the at least one authorized location.

15. The method of claim 13 wherein the meta data further specifies at least one user activity of interest with respect to the presentation of the information to the user, and wherein the users performance of the at least one activity of interest is reported to the information management server.

16. The method of claim 14 wherein the meta data further specifies at least one user activity of interest with respect to the presentation of the information to the user, and wherein the users performance of the at least one activity of interest is reported to the information management server.

17. The method of claim 13 wherein the information management server maintains a database of classes of which users can be members and step (ii) comprises selecting at least one class from the database of classes.

18. The method of claim 13 further comprising the step of caching copies of the information and metadata at the at least one of a plurality of computing devices to permit access the information to logged a logged in user who is a member of the at least one class when the at least one of a plurality of computing devices is offline.

19. The method of claim 18 further comprising the step of caching information regarding the at least one user activity of interest with respect to the presentation of the information to the user until the at least one computing device can communicate with the information management server and then forwarding the cached information to the information management server.

20. The method of claim 13 wherein the information management server maintains a database of locations at which users are authorized to access the information and step (ii) comprises selecting at least one location from the database of locations.
